(19) United States
(12) Patent Application Publication
(10) Pub. No.: US 2026/0081440 A1
(43) Pub. Date: Mar. 19, 2026

(54) POWER SUPPLY SYSTEM

(71) Applicant: TOYOTA JIDOSHA KABUSHIKI KAISHA, Toyota-shi (JP)

(72) Inventor: Yohei HOSOKAWA, Susono-shi (JP)

(73) Assignee: TOYOTA JIDOSHA KABUSHIKI KAISHA, Toyota-shi (JP)

(21) Appl. No.: 19/220,653

(22) Filed: May 28, 2025

(30) Foreign Application Priority Data
Sep. 18, 2024 (JP) 2024-160829

(51) Int. Cl. H02J 7/00; B60L 50/51; B60L 50/60; B60L 53/24; H02J 7/35

(52) U.S. Cl. CPC H02J 7/575; B60L 50/51; B60L 50/60; B60L 53/24; H02J 7/35; H02J 7/56; H02J 7/855; B60L 2210/10; B60L 2210/30; B60L 2210/40

(57) ABSTRACT

A power supply system includes a first battery, a second battery, a voltage converter connected to a power generator or an external power supply, and a series-parallel switching circuit configured to switch connection of the first and second batteries between series connection and parallel connection by turning on and off a plurality of relays. The power supply system performs charge equalization control, namely control of alternatingly performing a first battery charging process and a state-of-charge equalization process. The first battery charging process is a process of charging the first battery by turning on and off the relays. The state-of-charge equalization process is a process of equalizing the state of charge of the first battery and the state of charge of the second battery. The power from the power generator or the external power supply is supplied to the auxiliary equipment or the auxiliary battery during the state-of-charge equalization process.

### CROSS-REFERENCE TO RELATED APPLICATION

This application claims priority to Japanese Patent Application No. 2024-160829 filed on Sep. 18, 2024. The disclosure of the above-identified application, including the specification, drawings, and claims, is incorporated by reference herein in its entirety.

### BACKGROUND

### 1. Technical Field

The present disclosure relates to power supply systems, and more particularly to an in-vehicle power supply system including two batteries that can be connected either in series or in parallel for charging or discharging.

### 2. Description of Related Art

A series-parallel battery system that can switch connection of a plurality of batteries between series connection and parallel connection has been proposed as this type of power supply system (see, for example, Japanese Unexamined Patent Application Publication No. 2013-081316 (JP 2013-081316 A)). In this system, the connection mode at the start of charging is selected based on the temperature and state of charge (SOC) of a power supply device, and a charging current for the parallel connection mode is controlled using an upper limit value that is larger than an upper limit value of a charging current for the series connection mode that is applied to the power supply device.

### SUMMARY

Two batteries can be charged by the following methods. For example, in one method, two batteries are charged simultaneously by connecting them in series. In another method, two batteries are charged simultaneously by connecting them in parallel. In still another method, two batteries are alternately charged by alternately connecting them to a power supply. A high power supply voltage is used in the method in which two batteries are charged simultaneously by connecting them in series. A high power supply current is used in the method in which two batteries are charged simultaneously by connecting them in parallel. In the method in which two batteries are alternately charged, charging efficiency decreases when a loss in a circuit for charging one battery and a loss in a circuit for charging the other battery are different.

A primary object of a power supply system of the present disclosure is to improve efficiency in charging two batteries that can be connected either in series or in parallel with power from an in-vehicle power generator or an external power supply.

The power supply system of the present disclosure adopts the following measures in order to achieve the above primary object.

The power supply system of the present disclosure includes:
a first battery;
a second battery having the same configuration as the first battery;
a power converter connected to either or both of an in-vehicle power generator and an external power supply;
an auxiliary battery having a lower rated voltage than the first battery and the second battery and configured to supply power to auxiliary equipment;
a series-parallel switching circuit including a plurality of relays and configured to switch connection of the first battery and the second battery between series connection and parallel connection by turning on and off the relays; and
a control device configured to drive and control the relays of the series-parallel switching circuit.

The control device is configured to perform charge equalization control when the first battery and the second battery are to be charged with power from the power generator or the external power supply. The charge equalization control is control of alternately performing a first battery charging process and a state-of-charge equalization process. The first battery charging process is a process of charging the first battery by turning on and off the relays such that the first battery is charged with the power from the power generator or the external power supply. The state-of-charge equalization process is a process of equalizing the state of charge of the first battery and the state of charge of the second battery by charging the second battery with power from the first battery by turning on and off the relays such that the second battery is charged with the power from the first battery.

The control device is configured to supply the power from the power generator or the external power supply to the auxiliary equipment or the auxiliary battery during the state-of-charge equalization process.

The power supply system of the present disclosure is mounted on a vehicle and includes:
the first battery;
the second battery having the same configuration as the first battery;
the power converter connected to either or both of the in-vehicle power generator and the external power supply;
the auxiliary battery having a lower rated voltage than the first battery and the second battery and configured to supply power to the auxiliary equipment;
the series-parallel switching circuit including the relays and configured to switch connection of the first battery and the second battery between series connection and parallel connection by turning on and off the relays; and
the control device configured to drive and control the relays of the series-parallel switching circuit.

The control device is configured to perform the charge equalization control when the first battery and the second battery are to be charged with the power from the power generator or the external power supply. The charge equalization control is the control of alternately performing the first battery charging process and the state-of-charge equalization process. The first battery charging process is a process of charging the first battery by turning on and off the relays such that the first battery is charged with the power from the power generator or the external power supply. The state-of-charge equalization process is a process of equalizing the state of charge of the first battery and the state of charge of the second battery by charging the second battery with the power from the first battery by turning on and off the relays such that the second battery is charged with the power from the first battery.

The control device is configured to supply the power from the power generator or the external power supply to the auxiliary equipment or the auxiliary battery during the state-of-charge equalization process.

As described above, equalization of the state of charge of the first battery and the state of charge of the second battery is performed in a relatively short time. This allows the first battery and the second battery to be charged in the time during which the first battery is charged with the power from the power generator or the external power supply and the short time during which the equalization is performed. Therefore, charging efficiency can be improved. The charging efficiency can further be improved particularly when a loss in a circuit when the second battery is charged with the power from the power generator or the external power supply is larger than a loss in a circuit when the first battery is charged with the power from the power generator or the external power supply. Moreover, since the power from the power generator or the external power supply is supplied to the auxiliary equipment or the auxiliary battery during the state-of-charge equalization process, the power from the power generator or the external power supply can be effectively used even during the state-of-charge equalization process.

In the power supply system of the present disclosure,
the control device may be configured to charge the first battery and the second battery by selecting either a loss when series connection charge control is performed or a loss when the charge equalization control is performed, whichever is smaller. The series connection charge control is control of charging the first battery and the second battery connected in series with the power from the power generator or the external power supply by turning on and off the relays such that the first battery and the second battery are connected in series to the power generator or the external power supply. The first battery and the second battery can thus be charged more efficiently.

In the power supply system of the present disclosure,
the series-parallel switching circuit may include: a series connection line configured to connect an anode terminal of the first battery and a cathode terminal of the second battery; a series connection relay attached to the series connection line; a cathode bus connected to a cathode terminal of the first battery; an anode bus connected to an anode terminal of the second battery; an inverter connected to the cathode bus and the anode bus; a three-phase alternating current motor configured to be driven by the inverter; a cathode relay attached to the cathode bus; an anode relay attached to the anode bus; a first parallel connection line configured to connect the series connection line at a position closer to the first battery than the series connection relay and the anode bus; a first parallel connection relay attached to the first parallel connection line; a second parallel connection line configured to connect the cathode terminal of the second battery and a neutral point of the three-phase alternating current motor; and a second parallel connection relay and a third parallel connection relay that are attached to the second parallel connection line in order of the second parallel connection relay and the third parallel connection relay from the second battery.

The power generator and the external power supply may be connected via the power converter to power lines each including a charging relay. The power lines are connected, respectively, to the cathode bus at a position closer to the first battery than the cathode relay and to the anode bus at a position closer to the second battery than the anode relay.

The auxiliary equipment and the auxiliary battery may be connected to an auxiliary power line connected to the power converter.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram schematically showing the configuration of a power supply system according to an embodiment of the present disclosure;

FIG. 2 is a flowchart illustrating an example of a charging process performed by the electronic control unit;

FIG. 3 is a flowchart illustrating an example of charge equalization control performed by the electronic control unit;

FIG. 4 illustrates an example of a circuit when the first battery is charged;

FIG. 5 illustrates an example of a circuit in the equalization process; and

FIG. 6 illustrates an example how the first battery, the second battery, and the auxiliary battery are charged when the charge equalization control according to the embodiment is performed.

### DETAILED DESCRIPTION OF EMBODIMENTS

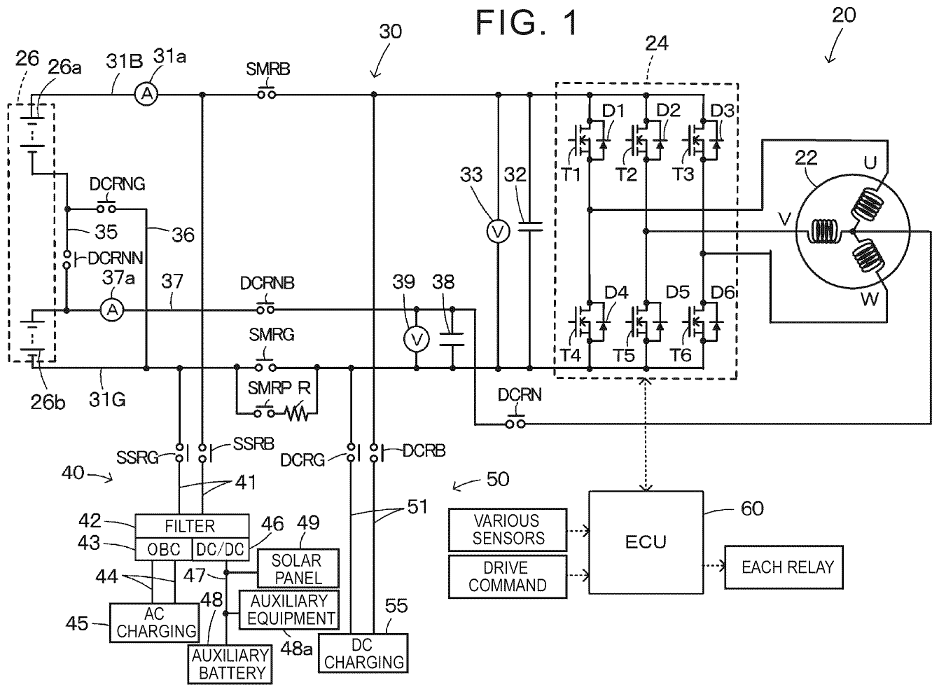

Next, a mode for carrying out the present disclosure (embodiment) will be described. FIG. 1 is a configuration diagram schematically showing the configuration of an in-vehicle power supply system 20 according to an embodiment of the present disclosure. The power supply system 20 of the embodiment is mounted on an electrified vehicle as a device configured to transfer power between the battery 26 and the inverter 24 that drives the motor 22. The power supply system 20 charges and discharges the battery 26 by using the motor 22 and the inverter 24 as necessary. The power supply system 20 includes a battery 26, a motor 22, an inverter 24, a power supply main circuit 30, an alternating current charging circuit 40, a direct current charging circuit 50, and an electronic control unit 60. The motor 22 functions as an electric motor for traveling electrified vehicle.

The motor 22 is configured as a well-known three-phase alternating current motor including, for example, a rotor having a permanent magnet attached to an outer surface thereof and a stator around which three-phase coils are wound. The inverter 24 includes six transistors T1 to T6 as switching elements, and six diodes D1 to D6 connected in parallel in the opposite direction from the transistors T1 to T6. The transistors T1 to T6 are arranged in pairs such that the inverter 24 serves as a source and a sink with respect to a cathode bus 31B and an anode bus 31G of the battery 26. Three-phase coils (U-phase, V-phase, and W-phase) of the motor 22 are connected to the connecting points of the pairs of transistors T1 to T6. The inverter 24 forms a rotating magnetic field in the three-phase coils by controlling the ratio of the on-time of T6 from the pair of transistors T1 while a voltage is applied between the cathode bus 31B and the anode bus 31G, and drives motor 22 to rotate. A first capacitor 32 for smoothing is attached between the cathode bus 31B and the anode bus 31G.

The battery 26 includes a first battery 26a and a second battery 26b configured similarly to the first battery 26a. The first battery 26a and the second battery 26b are configured as, for example, a lithium-ion secondary battery or a nickel-metal hydride secondary battery. The cathode terminal of the first battery 26a is connected to the cathode bus 31B, and the anode terminal of the second battery 26b is connected to the anode bus 31G. The anode terminal of the first battery 26a is connected to the cathode terminal of the second battery 26b by a series power line 35 to which a relay DCRNN included in the configuration of the power supply main circuit 30 is attached. Therefore, when the relay DCRNN is turned on, the first battery 26a and the second battery 26b function as one battery connected in series.

The power supply main circuit 30 includes a first parallel power line 36 and a second parallel power line 37 in addition to the cathode bus 31B, the anode bus 31G, and the series power line 35. The first parallel power line 36 connects the anode terminal of the first battery 26a and the anode bus 31G. The second parallel power line 37 connects the cathode terminal of the second battery 26b to the neutral point of the motor 22. A cathode relay SMRB is attached to the cathode bus 31B, and an anode relay SMRG is attached to the anode bus 31G. In addition, the anode bus 31G is provided with a pre-charge circuit including a pre-charge relay SMRP and a resistor R in parallel with the anode relay SMRG. The cathode relay SMRB, the anode relay SMRG, and the pre-charge circuit constitute a system main relay. That is, when the first battery 26a and the second battery 26b are connected in series, the cathode relay SMRB is turned on and the pre-charge relay SMRP is turned on to charge the first capacitor 32. When the charging of the first capacitor 32 is completed, the anode relay SMRG is turned on and the pre-charge relay SMP is turned off. Accordingly, the power from the battery 26 can be supplied to the inverter 24, and the battery 26 can be charged with the regenerative electric power from the motor 22. The battery 26 includes a first battery 26a and a second battery 26b connected in series.

A relay DCRNG is attached to the first parallel power line 36. A relay DCRNB is attached to the second parallel power line 37 at a position closer to the second battery 26b, and a relay DCRN is attached to the second parallel power line 37 at a position closer to the neutral point of the motor 22. A second capacitor 38 is attached between the relay DCRNB and the relay DCRN of the second parallel power line 37 and to the anode bus 31G.

The alternating current charging circuit 40 includes an alternating current charging power line 41 connected to the cathode bus 31B and the anode bus 31G. The alternating current charging circuit 40 includes an on-board charger (On Board Charger: OBC) 43 connected to an alternating current charging power line 41 via filters 42. The alternating current charging circuit 40 includes an AC charging connector 45 connected to the on-board charger 43 by a power line 44. The alternating current charging circuit 40 includes a DC/DC converter 46 connected in parallel with the on-board charger 43 to the alternating current charging power line 41 via filters 42. The alternating current charging circuit 40 includes an auxiliary battery and auxiliary equipment 48a connected to the DC/DC converter 46 by a power line 47, and a solar panel 49. A relay SSRB is attached to the cathode line of the alternating current charging power line 41, and a relay SSRG is attached to the anode line.

The direct current charging circuit 50 includes a direct current charging power line 51 connected to the cathode bus 31B and the anode bus 31G, and a DC charging connector 55 connected to the direct current charging power line 51. A relay DCRB is attached to the cathode line of the direct current charging power line 51, and a relay DCRG is attached to the anode line.

The electronic control unit 60 is configured as a microcomputer centered on a CPU, not shown. Signals from various sensors are input to the electronic control unit 60. Examples of the various sensors include a voltage sensor 33 that detects a voltage VH between terminals of the first capacitor 32 and a voltage sensor 39 that detects a voltage VD between terminals of the second capacitor 38. Examples of the various sensors include a current sensor 31a that detects a current Ib1 flowing through the first battery 26a and a current sensor 37a that detects a current Id flowing through the second parallel power line 37. Examples of the various sensors include a phase current sensor, not shown, that detects phase currents Iu, Iv, Iw flowing in the three phases of the motor 22. Examples of the various sensors include a voltage sensor, not shown, that detects a voltage Vb1 between terminals of the first battery 26a and a voltage sensor, not shown, that detects a voltage Vb2 between terminals of the second battery 26b. Since the electronic control unit 60 also functions as a control device that drives the motor 22, it also receives a drive command etc. When the power supply system 20 is mounted on a vehicle and the motor 22 is used as a motor for traveling, an accelerator operation amount and a vehicle speed may be input to the electronic control unit 60, and a torque command for the motor 22 may be generated by the electronic control unit 60.

The electronic control unit 60 outputs a drive control signal to each relay, a switching control signal to the inverter 24, and the like. Relays include a cathode relay SMRB, an anode relay SMRG, a pre-charge relays SMRP, a relay DCRNN, a relay DCRNG, a relay DCRNB, and a relay DCRN. The relays include a relay SSRB, a relay SSRB, a relay DCRB, a relay DCRG, etc.

In the power supply system 20 of the embodiment, when the motor 22 is driven as a driving motor, the cathode relay SMRB, the anode relay SMRG, the relay SSRB, the relay SSRG, and the relay DCRNN are turned on. Then, the relays DCRB, DCRG, DCRN, DCRB, and DCRG are turned off. Then, switching control of the six transistors T1 to T6 of the inverter 24 is performed by PWM control etc. based on a torque command according to the accelerator operation amount and the vehicle speed V.

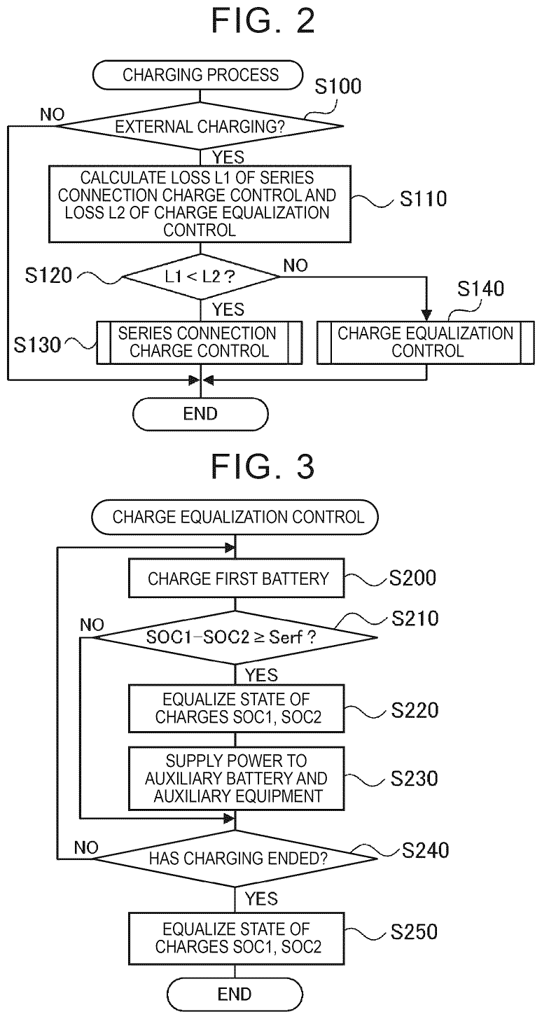

Next, an operation when an AC power supply is connected to the AC charging connector 45 and the battery 26 is charged with power from the AC power supply or when the battery 26 is charged with power generated by the solar panel 49 will be described. FIG. 2 is a flowchart illustrating an example of a charging process that is performed by the electronic control unit 60 when charging the battery 26 with power from the AC power supply or the solar panel 49. FIG. 3 is a flowchart illustrating an example of charge equalization control performed by the electronic control unit 60. The charge equalization control will be described later.

When the charging process is performed, the electronic control unit 60 determines whether the battery 26 is to be charged with the power from the AC power supply or the solar panel 49 (S100). For example, when the external direct current power supply is connected to the DC charging connector 55 and the battery 26 is charged with the power from the external direct current power supply, it is determined that the battery 26 is not to be charged with power from the AC power supply or the solar panel 49. In this case, the process ends because this process is not to be performed in this situation.

When it is determined in S100 that the battery 26 is to be charged with the power from the AC power supply or the solar panel 49, a loss L1 when the series connection charge control is performed is calculated. The series connection charge control is control for charging the first battery 26a and the second battery 26b by connecting them in series. Then, a loss L2 when the charge equalization control is performed is calculated (S110). In the charge equalization control, the first battery charging process and the equalization process are alternately repeated to charge the first battery 26a and the second battery 26b. The first battery charging process charges the first battery 26a. The equalization process equalizes the state of charge SOC1 of the first battery 26a and the state of charge SOC1 of the second battery 26b. In the series connection charge control, the relay SSRB, the relay SSRG, and the relay DCRNN are turned on. Then, the cathode relay SMRB, the anode relay SMRG, the relay DCRB, the relay DCRG, the relay DCRN, the relay DCRNB, the relay DCRB, and the relay DCRG are turned off. The battery 26 is then charged with power from the AC power supply or the solar panel 49. The loss L1 is a charge loss in the series connection charge control. Loss L1 is a loss of a circuit from the filter 42 through the relay SSRB back to the filter 42 through the cathode bus 31B, the first battery 26a, the relay DCRNN, the second battery 26b, the anode bus 31G, and the relay SSRG. The charge equalization control and its loss L2 will be described later.

Subsequently, the loss L1 when the series connection charge control is performed is compared with the loss L2 when the charge equalization control is performed (S120). When it is determined that the loss L1 when the series connection charge control is performed is smaller than the loss L2 when the charge equalization control is performed, the series connection charge control is performed (S130), and this process ends. On the other hand, when it is determined in S120 that the loss L1 when the series connection charge control is performed is equal to or larger than the loss L2 when the charge equalization control is performed, the charge equalization control is performed (S140), and this process ends.

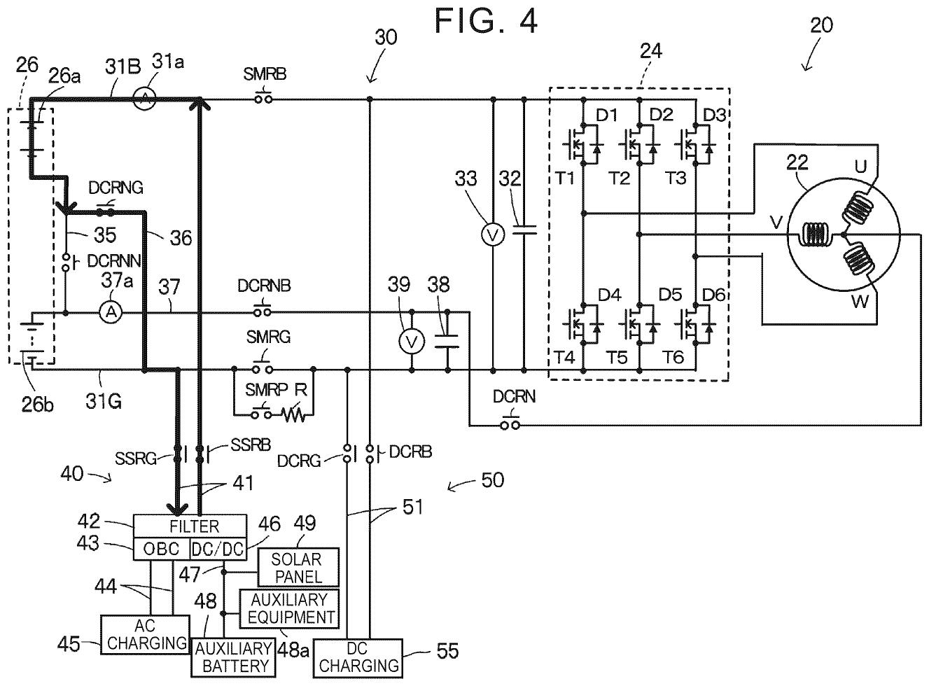

In the charge equalization control, as shown in the flowchart of FIG. 3, the electronic control unit 60 first charges the first battery 26a (S200). As shown in the illustration of FIG. 4, when the first battery 26a is charged, the relay SSRB, the relay SSRG, and the relay DCRNG are turned on. The cathode relay SMRB, the anode relay SMRG, the relay DCRNN, the relay DCRB, the relay DCRG, the relay DCRN, the relay DCRNB, the relay DCRB, and the relay DCRG are turned off. Then, a circuit is formed from the filter 42 through the relay SSRB to return to the filter 42 through the cathode bus 31B, the first battery 26a, the relay DCRNG, the first parallel power line 36, the anode bus 31G, and the relay SSRG. The first battery 26a is charged in this manner.

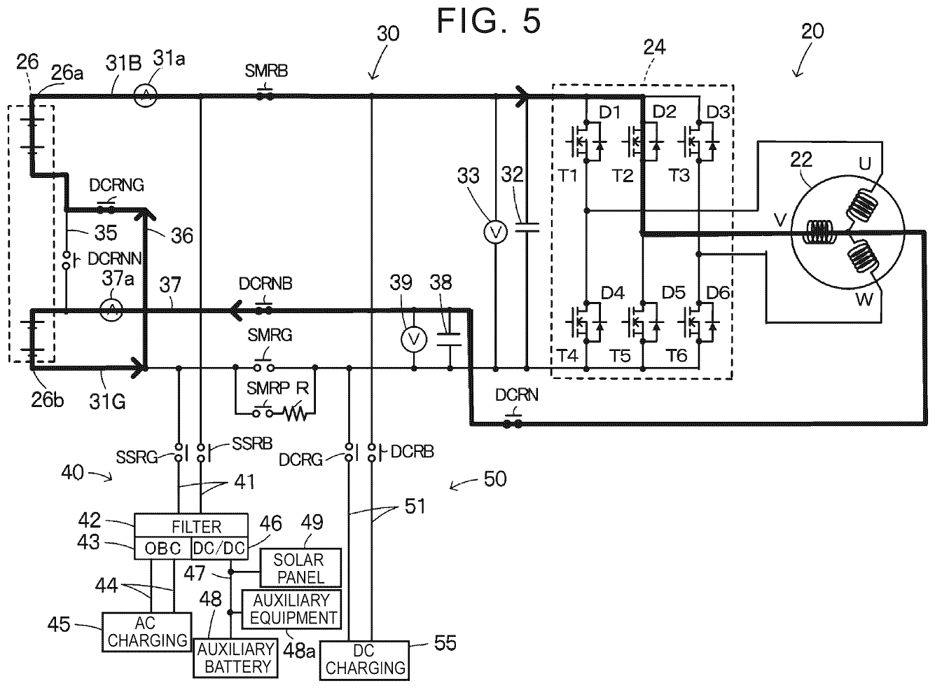

Next, it is determined whether or not the difference (SOC1-SOC2) between the state of charge SOC1 of the first battery 26a and the state of charge SOC1 of the second battery 26b is equal to or greater than the threshold Sref (S210). When it is determined that the difference (SOC1-SOC2) between the state of charge SOC1 of the first battery 26a and the state of charge SOC1 of the second battery 26b is equal to or larger than the threshold Sref, the following process is performed. The process of equalizing the state of charge SOC1 of the first battery 26a and the state of charge SOC1 of the second battery 26b is performed (S220). During the equalization process, power from the AC power supply or solar panel 49 is supplied to the auxiliary battery 48 or the auxiliary equipment 48a (S230). In the equalization process, as shown in the illustration of FIG. 5, the cathode relay SMRB, the relay DCRNG, the relay DCRN, and the relay DCRNB are turned on. Then, the relay SSRB, the relay SSRG, the cathode relay SMRB, the anode relay SMRG, the relay DCRNN, the relay DCRB, and the relay DCRG are turned off. Further, any one or two or all of the transistors T1, T2, T3 of the inverter 24 are turned on. Then, a circuit is formed from the cathode terminal of the first battery 26a to the anode terminal of the first battery 26a via the cathode bus 31B, the cathode relay SMRB, the transistors T1, T2, T3 of the inverter 24, the motor 22, the second parallel power line 37, the relay DCRN, the relay DCRNB, the second battery 26b, the anode bus 31G, the first parallel power line 36, and the relay DCRNG. The equalization process is performed in this manner. Power from the solar panel 49 can be supplied to the auxiliary battery 48 and the auxiliary equipment 48a through the power line 47. In addition, the power from the AC power supply can be supplied to the auxiliary battery 48 and the auxiliary equipment 48a by the on-board charger 43 and the DC/DC converter 46 by supplying power to the power line 47. When it is determined in S210 that the difference (SOC1-SOC2) between the state of charge SOC1 of the first battery 26a and the state of charge SOC1 of the second battery 26b is less than the threshold Sref, the equalization process is not performed.

Subsequently, it is determined whether charging of the battery 26 has ended (S240). The end of the charging of the battery 26 includes when the first battery 26a and the second battery 26b are fully charged, when the vehicle is prepared to start traveling, etc. When it is determined that the charging of the battery 26 has not ended, the process returns to the process of S200, namely the process of charging the first battery 26a. The process of S200 to S240 includes a process of alternately repeating a process of charging the first battery 26a, an equalization process, and a supply process until it is determined that the charging has ended. In the process of charging the first battery 26a, the first battery 26a is charged until the difference between the state of charge SOC1 of the first battery 26a and the state of charge SOC2 of the second battery 26b becomes equal to or larger than the threshold Sref. The equalization process is a process of equalizing the state of charge SOC1 of the first battery 26a and the state of charge SOC2 of the second battery 26b. The supply process is a process of supplying the power from the AC power supply or the solar panel 49 to the auxiliary battery 48 or the auxiliary equipment 48a during the equalization process. Note that the loss L2 when the charge equalization control is performed is a loss when the process of charging the first battery 26a and the process of equalizing the state of charge SOC1 of the first battery 26a and the state of charge SOC2 of the second battery 26b are alternately performed.

When it is determined in S230 that the charging has ended, the equalization process is performed (S240), and the process ends. The equalization process is performed last in order to make the state of charge SOC1 of the first battery 26a and the state of charge SOC2 of the second battery 26b the same.

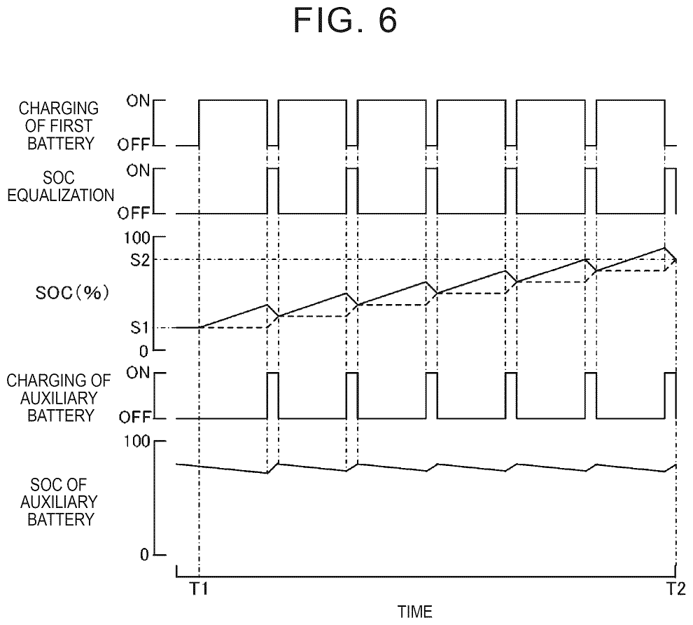

FIG. 6 illustrates an example of how the first battery 26a, the second battery 26b, and the auxiliary battery 48 are charged when the charge equalization control according to the embodiment is performed. Regarding the state of charge SOC in the figure, a continuous line indicates the state of charge SOC1 of the first battery 26a, and a dashed line indicates the state of charge SOC2 of the second battery 26b. In the charge equalization control of the embodiment, as in the case of charging the second battery 26b in the equalization process, the loss is large because this control is performed via the transistors T1, T2, T3 of the inverter 24 and the motor 22. However, since the equalization process ends in a short time, the loss is small as a whole. That is, in the embodiment, the charging of the first battery 26a having a high-efficiency charging is mainly performed. Although the equalization process is performed in a short time, the state of charge SOC of the auxiliary battery 48 increases during the equalization process because the power from the AC power supply or the solar panel 49 is supplied to the auxiliary battery 48 or the auxiliary equipment 48a. Since the power from the AC power supply or the solar panel 49 is supplied to the auxiliary battery 48 or the auxiliary equipment 48a during the equalization process, the power from the AC power supply or the solar panel 49 can be more effectively used.

In the power supply system 20 of the embodiment, the following process is performed when the battery 26 is to be charged with the power from the AC power supply or the solar panel 49. That is, when the loss L1 when the series connection charge control is performed is equal to or larger than the loss L2 when the charge equalization control is performed, the charge equalization control is performed to charge the battery 26. Therefore, the charging time can be shortened and the charging efficiency can be increased as compared with the case where the battery 26 is charged by performing alternating charge control in which the charging of the first battery 26a and the charging of the second battery 26b are alternately performed. Moreover, the power from the AC power supply or the solar panel 49 can be more effectively utilized by supplying the power from the auxiliary battery 48 or the auxiliary equipment 48a during the equalization process, the power from the AC power supply or the solar panel 49.

In the power supply system 20 of the embodiment, when the battery 26 is charged with power from the AC power supply or the solar panel 49, the battery 26 is charged in the following manner. That is, the battery 26 is charged by selecting either the loss L1 when the series connection charge control is performed or the loss L2 when the charge equalization control is performed, whichever is smaller. As a result, the charging efficiency can be further increased.

The correspondence between the main elements of the embodiments and the main elements of the disclosure described in the column of the means for solving the problem will be described. In an embodiment, the first battery 26a is an example of the “first cell.” The second battery 26b is an example of the “second battery.” The solar panel 49 is an example of the “power generator.” The on-board charger 43 and the DC/DC converter 46 are examples of the “voltage converter.” The auxiliary battery 48 is an example of the “auxiliary battery.” The auxiliary equipment 48a is an example of the “auxiliary equipment.” The power supply main circuit 30 is an example of the “series-parallel switching circuit.” The electronic control unit 60 is an example of the “control device.” The power supply system 20 is an example of the “power supply system.”

The correspondence between the main elements of the embodiment and the main elements of the disclosure described in the section of the means for solving the problem is an example for specifically explaining the embodiment of the disclosure described in the section of the means for solving the problem. Therefore, these are not intended to limit the elements of the disclosure described in the section of the means for solving the problem. That is, the interpretation of the disclosure described in the section of the means for solving the problem should be performed based on the description in the section, and the embodiments are merely specific examples of the disclosure described in the section of the means for solving the problem.

Although the present disclosure has been described above using the embodiment, the present disclosure is not limited to the embodiment in any way, and may be implemented in various modes without departing from the scope of the present disclosure.

The present disclosure is applicable to a manufacturing industry of a power supply system and the like.

What is claimed is:

1. A power supply system configured to be mounted on a vehicle, the power supply system comprising:
a first battery;
a second battery having the same configuration as the first battery;
a power converter connected to either or both of an in-vehicle power generator and an external power supply;
an auxiliary battery configured to supply power to auxiliary equipment, the auxiliary battery having a lower rated voltage than the first battery and the second battery;
a series-parallel switching circuit including a plurality of relays, the series-parallel switching circuit being configured to switch connection of the first battery and the second battery between series connection and parallel connection by turning on and off the relays; and
a control device configured to drive and control the relays of the series-parallel switching circuit, wherein:
the control device is configured to perform charge equalization control when the first battery and the second battery are to be charged with power from the power generator or the external power supply, the charge equalization control being control of alternately performing a first battery charging process and a state-of-charge equalization process, the first battery charging process being a process of charging the first battery by turning on and off the relays such that the first battery is charged with the power from the power generator or the external power supply, and the state-of-charge equalization process being a process of equalizing a state of charge of the first battery and a state of charge of the second battery by charging the second battery with power from the first battery by turning on and off the relays such that the second battery is charged with the power from the first battery; and
the control device is configured to supply the power from the power generator or the external power supply to the auxiliary equipment or the auxiliary battery during the state-of-charge equalization process.

2. The power supply system according to claim 1, wherein the control device is configured to charge the first battery and the second battery by selecting either a loss when series connection charge control is performed or a loss when the charge equalization control is performed, whichever is smaller, the series connection charge control being control of charging the first battery and the second battery connected in series with the power from the power generator or the external power supply by turning on and off the relays such that the first battery and the second battery are connected in series to the power generator or the external power supply.

3. The power supply system according to claim 1, wherein:
the series-parallel switching circuit includes
a series connection line configured to connect an anode terminal of the first battery and a cathode terminal of the second battery,
a series connection relay attached to the series connection line,
a cathode bus connected to a cathode terminal of the first battery,
an anode bus connected to an anode terminal of the second battery,
an inverter connected to the cathode bus and the anode bus,
a three-phase alternating current motor configured to be driven by the inverter,
a cathode relay attached to the cathode bus,
an anode relay attached to the anode bus,
a first parallel connection line configured to connect the series connection line at a position closer to the first battery than the series connection relay and the anode bus,
a first parallel connection relay attached to the first parallel connection line,
a second parallel connection line configured to connect the cathode terminal of the second battery and a neutral point of the three-phase alternating current motor, and
a second parallel connection relay and a third parallel connection relay that are attached to the second parallel connection line in order of the second parallel connection relay and the third parallel connection relay from the second battery;
the power generator and the external power supply are connected via the power converter to power lines each including a charging relay, the power lines being connected, respectively, to the cathode bus at a position closer to the first battery than the cathode relay and to the anode bus at a position closer to the second battery than the anode relay; and
the auxiliary equipment and the auxiliary battery are connected to an auxiliary power line connected to the power converter.
